(19) United States
(12) Patent Application Publication
(10) Pub. No.: US 2015/0289492 A1
(43) Pub. Date: Oct. 15, 2015

(54) FISHING LINE CONCEALMENT DEVICE

(71) Applicant: Justice Tackle & Co., LLC, Jupiter, FL (US)

(72) Inventor: Christopher Walsh, Jupiter, FL (US)

(21) Appl. No.: 14/682,907

(22) Filed: Apr. 9, 2015

Related U.S. Application Data
(60) Provisional application No. 61/977,534, filed on Apr. 9, 2014.

(51) Int. Cl. A01K 91/06; A01K 97/00

(52) U.S. Cl. CPC A01K 91/06; A01K 97/00

(57) ABSTRACT

A device for attachment to a fishing line and capable of shearing water to create a bubble trail along a length of the fishing line. The device is preferably mounted at the beginning of a leader line and, when pulled through the water at trolling speeds, causes water shear. The device is formed from a housing having at least one aperture constructed and arranged to cause the static pressure in water passing through the aperture while at a trolling speed, wherein water is reduced to below the vapor pressure forming a gaseous state of bubbles effective for concealing a length of the fishing line.

### PRIORITY CLAIM

This application is based upon and claims the priority date of U.S. Provisional Patent Application No. 61/977,534 filed Apr. 9, 2014, entitled “Fishing Line Concealment Device,” the contents of which is incorporated herein by reference.

### FIELD OF THE INVENTION

This invention is directed to the field of fishing, and in particular to a device capable of producing a stream of air bubbles for use in concealing a portion of a fishing leader line.

### BACKGROUND OF THE INVENTION

Fishing dates back to the Paleolithic period. Since that time fish were caught for commercial and recreational purposes. A universally accepted method of catching fish is commonly referred to as angling, wherein a rod and reel combination is used for tethering a fish hook at the end of fishing line. While the use of a rod and reel combination is commonplace, countless types of lures have been secured to the end of a fishing line in order to entice a fish to take the bait. While the lures can be of most any shape, size, or material, all must include a hook for capturing a fish. While great care has been made to conceal the hook, the fishing line must be secured to the lure which can scare away a fish despite the tempting lure. Present day fishing lines may be nylon, polyethylene, polyester, monofilament, multifilament, fluoro-carbon, stainless steel wire, or even braided elements to name just a few. The type of fish sought determines the optimum fishing line and technique such as trolling, deep drop, casting, and so forth. Larger fish require thicker diameter lines which are easy to spot in the water. Fishing lines used for trolling are even more difficult to conceal as the lines must be large enough to handle pressures due to dragging of lures. Trolling is a type of fishing used to catch roaming fish. Trolling, whether near shore or offshore, is often the most productive method for catching a variety of blue water pelagic fish and near shore salt water fish. Unfortunately, many opportunities are lost due to the use of a fishing line that is easily detected by the fish.

The fishing line required for trolling is typically larger than what is used for passive fishing due to both the size of the fish targeted and the pressure placed on the line from pulling a lure or bait through the water behind the vessel. Trolling can be broken down into four categories: fast, slow, shallow or deep. Shallow trolling refers to the bait, not the depth of water; and is generally used in blue water, wherein the water may be hundreds of feet deep and the bait is literally on the surface. Shallow trolling is used by anglers looking mainly for billfish, Wahoo, or dolphin which feed on schools of bait such as ballyhoo, flying fish, small bonito and the like. The natural escape mechanism for these baitfish is to literally skip along the surface of the water for some distance. A fishing line or leader line must be strong enough to prevent pelagic fish from biting through the line or from a tail kick. The result is line sizing that is large enough to scare away the fish. Trolling of baits can further highlight the lines and lures; the speed of the trolling boat can even make a difference. A slow trolling speed is where a vessel drags the bait behind the vessel at speeds varying from three to six knots. A high trolling speed is where a vessel drags the bait behind the vessel at speeds varying from six to twelve knots. In many instances the fisherman does not have the luxury of changing line sizes while fishing, and the hook size needs to match the bait. For this reason, a sport fisherman may carry pre-rigged leaders with hooks from 5/0 to 9/0 having leader lines that vary in test strength, size and material. However, the fisherman may not be able to simply switch out fishing lines which can be hundreds of yards long. As a result, the fisherman may size the fishing line for minimal detection and rely upon a sized leader line in hopes that the fish will not detect either the fishing line or the leader line.

By way of example, Wahoo is a pelagic fish with razor sharp teeth. Wahoo and Dolphin (also known as Mahi-mahi or Dorado) may strike a line at upwards of 50 mph, requiring a strong fishing line which makes it easier to be seen by the fish. A fisherman may be fortunate enough to have an all stainless steel line, but is more likely to use a monofilament fishing line with a stainless steel or a filament line upwards of 801b. test as a leader line. In this example, the fishing line may have a 301b. rating and a leader made of 801b. test. No matter the type of fish sought or the bait employed, the fishing leader line remains an issue if detected. Of particular concern is the attachment to the lure, wherein the attachment makes for a conspicuous connection that can be seen by the fish.

What is needed in the art is a device to help camouflage a portion of the fishing line while trolling, and in particular conceal the leader line to lure connection.

### SUMMARY OF THE INVENTION

Disclosed is a fishing line concealment device capable of shearing water to create a bubble trail along a length of the fishing line. The device is preferably mounted at the beginning of a leader line or at the fishing line/lure coupling. When the concealment device is pulled through the water at trolling speeds, a water shear is created by directionally positioned apertures in the device constructed and arranged to create a bubble stream from the water shear. The bubble stream flows along a length of the fishing line until the bubbles dissipate. The result is a stream of bubbles that camouflage the line.

An objective of the invention is to teach a fishing line concealment device capable of creating a bubble trail along a length of the fishing line.

Another objective of the invention is to teach a fishing line concealment device that can be placed at the connection of a fishing line to a leader line to help conceal the connection.

Yet another objective of the invention is to teach a fishing line concealment device that can be placed at the connection of a fishing line to a lure to help conceal the connection and/or hook.

Still another objective of the invention is to teach a fishing line concealment device that operates at common lure low speed trolling speeds varying from three knots to six knots.

Still another objective of the invention is to teach a fishing line concealment device that operates at common lure high speed trolling speeds varying from six knots to twelve knots.

Other objectives, advantages and benefits of this invention will become apparent from the following description taken in conjunction with any accompanying drawings wherein are set forth, by way of illustration and example, certain embodiments of this invention.

### BRIEF DESCRIPTION OF THE DRAWINGS

FIG. 1 is a perspective view of the instant invention;

FIG. 2 is a cross sectional side view taken along lines AA of FIG. 1;

FIG. 3 is a pictorial view;

FIG. 4 is a side view of an embodiment having embedded orifices; and

FIG. 5 is a top view of an embodiment having angled apertures.

### DETAILED DESCRIPTION OF THE PREFERRED EMBODIMENT

The present invention will now be described more fully with reference to the accompanying drawings in which alternate embodiments of the invention are shown and described. It is to be understood that the invention may be embodied in many different forms and should not be construed as limited to the illustrated embodiments set forth herein. Rather, these embodiments are provided so that this disclosure may be thorough and complete, and will convey the scope of the invention to those skilled in the art.

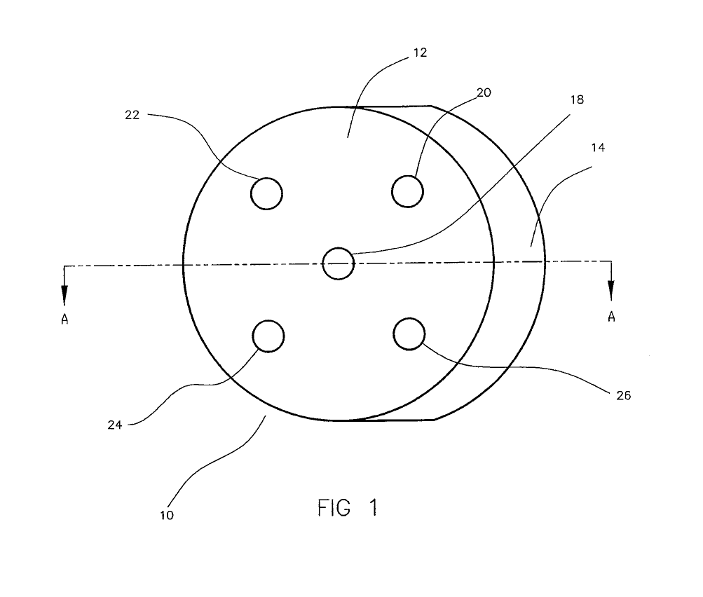

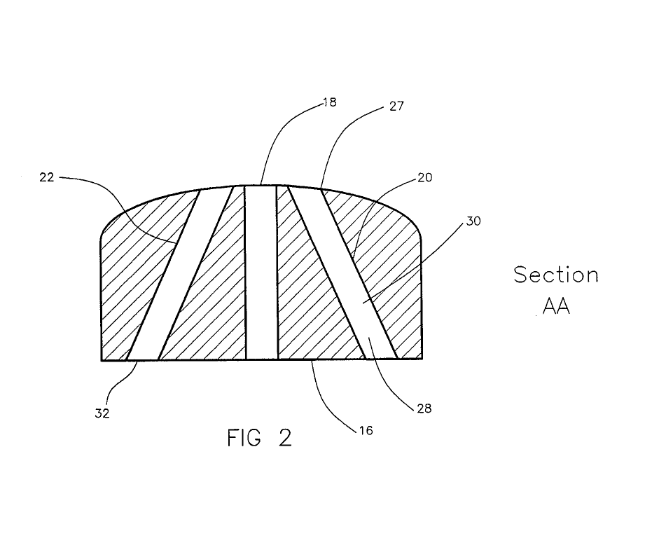

Referring to the figures, set forth is a fishing line concealment device capable of shearing water by use of apertures and/or an orifice capable of reducing water that passes through a housing 10 to a gaseous state causing bubbles to form, thereby concealing a length of fishing line behind the housing 10. Referring to FIGS. 1 and 2, set forth is a housing 10 having a front surface 12, side surface 14 and rear surface 16. A centrally disposed passageway 18 is sized for placement of a fishing line. Positioned around the passageway 18 are a series of flow through apertures depicted by numerals 20, 22, 24 and 26. Each aperture is constructed and arranged to allow water to flow through an entry opening located along the front surface 12 of the housing 10 and leave the aperture through an exit aperture at a controlled velocity causing vapor pressure of the water, resulting in the gaseous state. As shown in FIG. 2, aperture 20 has an entry opening 27 and an exit opening 28. Water flowing through the entry opening 27 is forced through channel 30 of the aperture 20 where a change in the static pressure passing through the aperture forms vapor cavities in the water as a result of the rapid change of pressure caused by the formation of cavities. The result is a stream of bubbles formed through each aperture at trolling speeds ranging from three to six knots for slow trolling; larger apertures allow for the formation of bubbles at trolling speeds varying from six to twelve knots.

The housing can be formed of most any material capable of containing an aperture that can be sized for a flow rate through apertures to create the aforementioned vapor pressure. At least one aperture is necessary, although multiple apertures as depicted in FIG. 1 are utilized to provide a preferred embodiment by controlling the balance of pressure exhibited on the housing while being passed through water. The placement of the apertures around the passageway equal or otherwise balance the flow rate so that the housing tracks true in the water.

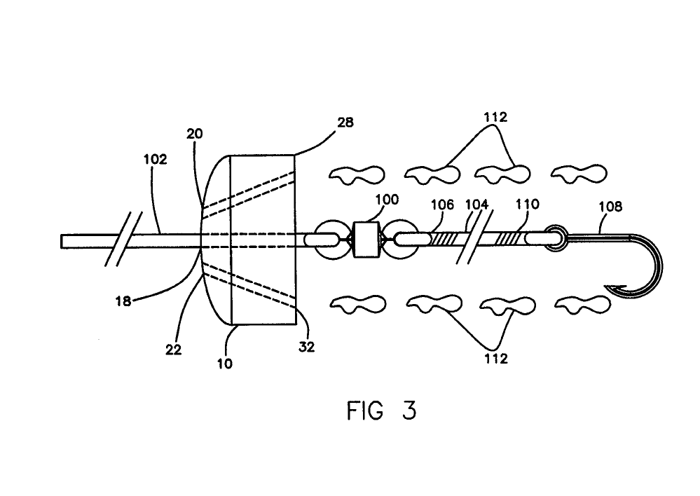

The housing 10 preferably includes a conical-shaped upper surface 12 and a cylindrical body. The passageway 18 is sized to permit a fishing line to pass through with particular advantages if placed before a leader line attachment, such as that shown in FIG. 3. A leader line attachment typically includes a swivel 100 wherein fishing line 102 leads from a rod and reel (not shown) and terminates in a swivel 100. The swivel is attached to a leader line 104, by a Bimini Twist 106, or alike knot. The proximal end of the leader line 104 may be secured to the swivel 100 or a snap hook, not shown, with the distal end secured to a fishing hook 108, or other type of lure by use of a line knot 110. The device positions the housing 10 before the leader line with the apertures 20 and 22 as depicted, adjacent to the passageway 18, with exit openings 28 and 32 resulting in the bubble formation 112 used to conceal the fishing line, and further benefit the fishing experience by creating what is known in trolling as smoke in the water by leaving a trail of bubbles.

Each aperture is constructed and arranged to cause the static pressure in water passing through the aperture to form vapor cavities in the water due to a rapid change of pressure that caused the formation of cavities where the pressure is relatively low. When the water is subjected to a higher pressure, the voids formed by the vapor cavities implode. Fluid is forced through each aperture with a narrowing of the flow path either through the shape of the aperture or by inclusion of an orifice within the aperture. With increasing flow rate of the water, turbulence becomes so strong that tiny cavitation nuclei are formed. These nuclei grow immediately downstream of the nucleation zone into a cloud of bubbles. Further away from the moving body the pressure conditions are such that the bubbles can no longer grow and eventually collapse. This creates the previously mentioned implosions. The visible effect of the cloud of growing and collapsing bubbles conceals the fishing line. When the device is placed at the beginning of the leader line, the bubbles follow along the length of the leader line in a plume that conceals the leader line.

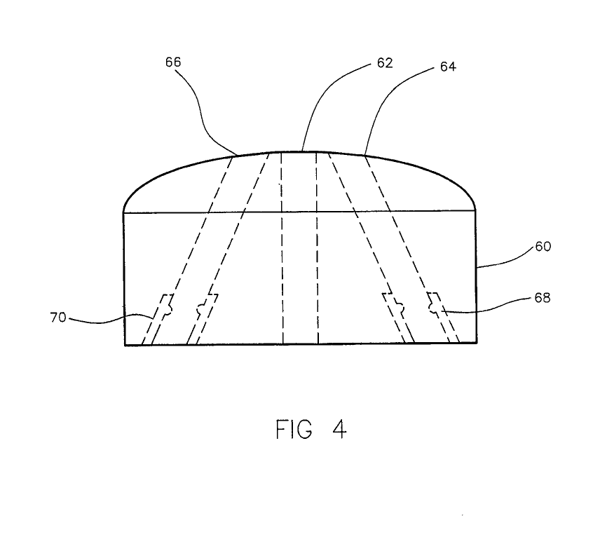

The housing may be formed from plastic or metal, either of which can be constructed to include apertures having reduction in size to cause the growth of bubbles by the formation of cavitation nuclei. Further, the housing can also be constructed from a material for receipt of orifice inserts 68 or 70. The orifice inserts operate in the same manner as the previous mentioned apertures, however the orifices allow formation of the cavitation nuclei in materials that are not otherwise manufactured with apertures sized to create the water shear. Referring to FIG. 4, set forth is a housing made from materials that may not be susceptible to precise aperture formation, such as lead or a lead substitute. Dense metals are commonly used for adding weight to line without adding mass and, at certain trolling speeds, is useful in maintaining the leader line a distance beneath the water surface. For this embodiment, the housing 60 has a passageway 62 and depicted apertures 64 and 66. Aperture 64 includes an orifice 68 which is implanted inthe aperture 64, either during the formation of the housing during the housing forming stage, or the orifice 68 can be inserted after the housing 60 is formed, the aperture sized large enough to allow the orifice to be inserted into the aperture. Similarly, orifice 70 is shown placed in aperture 66. The orifice may be made from a plastic, stainless steel, or other formable material that can be sized to provide formation of bubbles when drawn through the water.

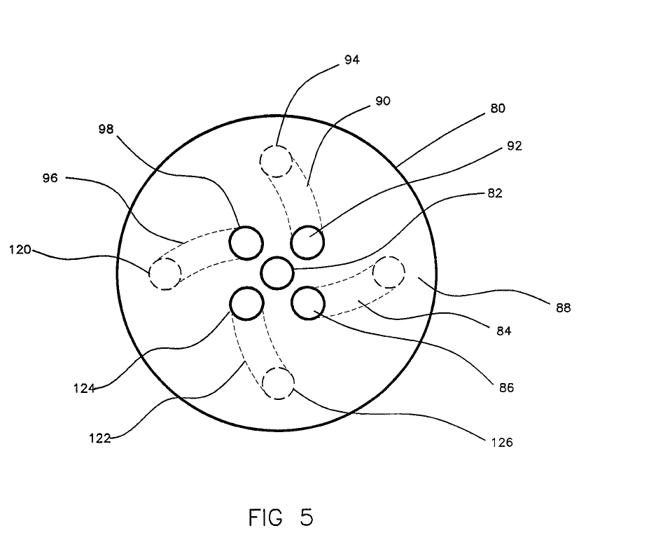

FIG. 5 is yet another embodiment depicting the housing 80 having a central passageway 82 for receipt of the fishing line. In this embodiment, aperture 84 has an entry opening 86 at an angular position to exit opening 88. The curvature of the aperture, or angle thereto, causes a swirling effect of the bubbles as they exit the housing. Aperture 90 has an entry opening 92 set at an angle from exit opening 94, located on the bottom of the housing. Aperture 96 has an entry opening 98 separate from an exit opening 120. Aperture 122 includes an entry opening 124, set at an angular position to exit opening 126.

The actual diameter of the housing can be made most any size, but is preferably a small diameter so as to reduce the pressure placed on the fishing line, as the frontal surface of the housing 10, also shown as housing 60 and 80 in the alternative embodiments, is pulled through the water. The conical-shaped frontal surface 12 further helps deflect weed lines and other debris from getting caught on the attachment of the leader line near the swivel. Many types of trolling bait have nearly concealed hooks so the additional curvature of the frontal section helps keep the bait from becoming fouled with sea debris. The depth of the housing need only be sufficient to support the aperture through a calculated diameter in relation to the depth to cause the aforementioned bubbling effect. The aperture can further be varied in size to cause either a continuous flow of bubbles or periodic bubbling, the effects of which are similar.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A fishing line concealment device comprising: a housing releasably secured to a fishing line, said housing having a frontal surface spaced apart from a rear surface by a continuous side wall; a centrally disposed passageway extending from said frontal surface to said rear surface sized to receive a fishing line; and at least one aperture having an inlet entry opening located on said frontal surface fluidly coupled to an outlet opening located on said rear surface, each said aperture constructed and arranged to allow water passing though said inlet to reach vapor pressure causing a gaseous state of air bubbles upon exiting from said outlet; whereby a fishing line is attached to said housing by insertion through said passageway, wherein said housing is drawn through water at a trolling speed which forces water through each said aperture forming air bubbles for use in concealing a portion of the fishing line.

2. The fishing line concealment device according to claim 1 wherein said housing sidewall is substantially cylindrical and said frontal surface is conical shaped.

3. The fishing line concealment device according to claim 1 wherein said passageway includes a diameter equal to or larger than a fishing line.

4. The fishing line concealment device according to claim 1 wherein each said inlet entry opening is positioned a first distance from said passageway and said outlet opening placed a second distance from said passageway, said first distance is equal to said second distance and parallel to said passageway.

5. The fishing line concealment device according to claim 1 wherein each said inlet entry opening is positioned a first distance from said passageway and an outlet opening placed a second distance from said passageway, said first distance is not equal to said second distance.

6. The fishing line concealment device according to claim 1 wherein at least one outlet opening is juxtapositioned to said passageway wherein bubbles engage the fishing line.

7. The fishing line concealment device according to claim 1 wherein each said inlet entry opening and corresponding outlet opening is positioned at an angle to said passageway wherein water flowing through each said aperture is rotated around at least a portion of the fishing line.

8. The fishing line concealment device according to claim 1 wherein each said aperture includes an insertable orifice.

9. The fishing line concealment device according to claim 8 wherein each said insertable orifice is secured to said outlet opening.

10. The fishing line concealment device according to claim 1 wherein said housing is constructed offerrous metal.

11. The fishing line concealment device according to claim 1 wherein said housing is constructed from plastic.

12. A fishing line concealment device comprising: a housing releasably secured to a fishing line, said housing having a conical shaped frontal surface spaced apart from a rear surface by a substantially circular and continuous side wall; a centrally disposed passageway extending from said frontal surface to said rear surface sized to receive a fishing line; and a plurality of apertures having an inlet entry opening on said frontal surface positioned a first distance from said passageway fluidly coupled to an outlet opening placed on said rear surface positioned a second distance from said passageway, each said aperture constructed and arranged to allow water passing though said inlet to reach vapor pressure causing a gaseous state of air bubbles upon exiting from said outlet; whereby a fishing line is attached to said housing by insertion through said passageway, wherein said housing is drawn through water at a trolling speed which forces water through each said aperture forming air bubbles for use in concealing a portion of the fishing line.

13. The fishing line concealment device according to claim 12 wherein said passageway includes a diameter equal to or larger than a fishing line.

14. The fishing line concealment device according to claim 12 wherein each said first distance is equal to said second distance.

15. The fishing line concealment device according to claim 12 wherein each said first distance does not equal said second distance.

16. The fishing line concealment device according to claim 12 wherein each said inlet entry opening and corresponding outlet opening is positioned at an angle to said passageway wherein water flowing through each said aperture is rotated around at least a portion of the fishing line.

17. The fishing line concealment device according to claim 1 wherein each said aperture includes an insertable orifice.

18. The fishing line concealment device according to claim 17 wherein each said insertable orifice is secured to said outlet opening.
